(19) United States
(12) Patent Application Publication
(10) Pub. No.: US 2007/0150959 A1
(43) Pub. Date: Jun. 28, 2007

(54) Inter-process authentication via a copyrighted value

(75) Inventors: Isaac P. Ahdout, Bellevue, WA (US); Martin H. Hall, Sammamish, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/300,520

(22) Filed: Dec. 14, 2005

(51) Int. Cl. H04N 7/16

(52) U.S. Cl. 726/26

(57) ABSTRACT

To put developers or other user or administrative personnel on notice that IP rights exist corresponding to an interprocess message, a trademarked or copyrighted value may be included in an interprocess message and validated by a receiving process before acceptance of the message. The use of a trademarked or a copyrighted value when constructing a message makes obvious to a developer that IP rights exist, both in the trademarked or copyrighted value, but presumably also in an associated schema or format associated with the message itself

### BACKGROUND

Interprocess communication has been performed in various ways for many decades. TCP and UDP using socket interfaces, IPX calls, remote procedure calls, and simple semaphores are but a few examples of communication techniques used between processes running on the same host and processes running on separate hosts. Many application program interfaces and development environments supporting interprocess communication were clearly copyrighted or built on proprietary or patented technology. Often, compiled and licensed object files were the only way to access these proprietary interfaces. However, some recent developments, for example, XML, require only text data, often including embedded text endpoint references to accomplish interprocess communication. Construction of such text data interfaces are often left to the developer using whatever tools or mechanisms they choose. Often, it is not apparent to developers or other users that a particular text data interface, such as an XML schema, used for interprocess communication is proprietary, patented content.

### SUMMARY

Requiring specific copyrighted content to be part of a text-based interprocess communication interface, particularly copyrighted content that is abstract with respect to the purpose of the communication or message payload, puts developers, administrators, or other involved personnel on notice that a particular interface, such as an XML schema, includes proprietary, protected content. Enforcement of use of the copyrighted content may be a function of the receiving process, whether it be for storage, execution, routing, or heartbeat. The copyrighted content may be embedded in either or both a header portion or a message payload portion of the interprocess communication. When the receiving process does not find an expected, copyrighted value, the receiving process may reject the message or otherwise refuse to process the data included.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a method of performing inter-process authentication using indicia including a copyrighted value or trademark;

FIG. 4 is a simplified and representative block diagram of an interprocess message; and

FIG. 5 is a method of building and sending an interprocess message with indicia including a copyrighted value or trademark.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

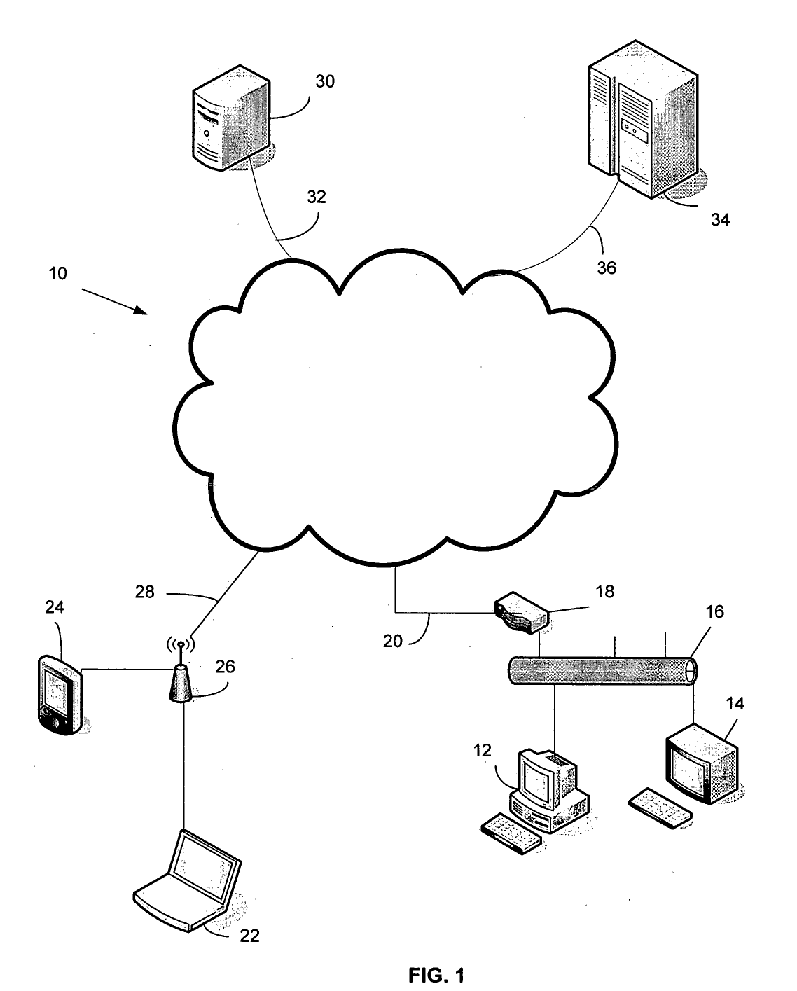

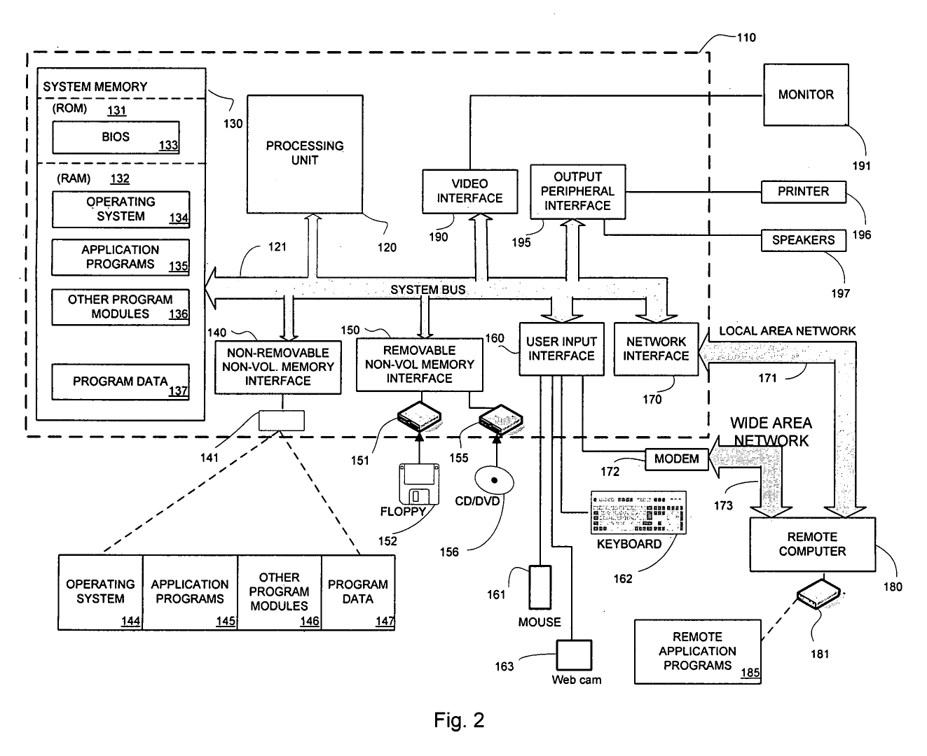

FIGS. 1 and 2 provide a structural basis for the network and computational platforms related to the instant disclosure.

FIG. 1 illustrates a network 10. The network 10 may be the Internet, a virtual private network (VPN), or any other network that allows one or more computers, communication devices, databases, processes, peer-to-peer network endpoints, etc., to be communicatively connected to each other. The network 10 may be connected to a personal computer 12, and a computer terminal 14 via an Ethernet 16 and a router 18, and a landline 20. The Ethernet 16 may be a subnet of a larger Internet Protocol network. Other networked resources, such as projectors or printers (not depicted), may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. The network 10 may be useful for supporting peer-to-peer network traffic.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163 , such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through-an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may, also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

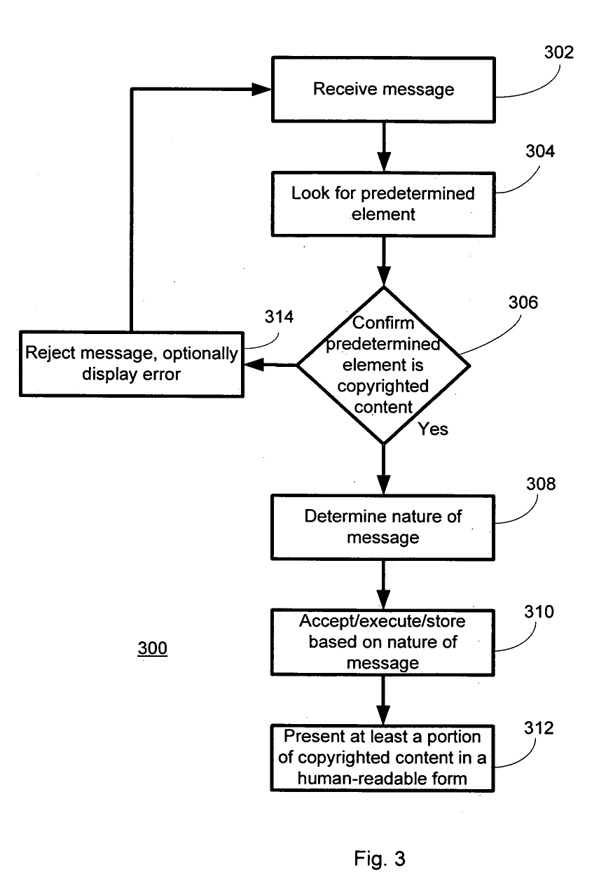

FIG. 3 is a method 300 of using legally enforceable indicia to perform interprocess authentication. The computer 110 of FIG. 1 or any of the devices, processes, peer-to-peer network endpoints, firmware, hardwired logic, etc., as exemplified by FIG. 1 may be configured for interprocess or other data communication. For the purpose of illustration and not limitation, the computer 110 of FIG. 2 will be used in the exemplary embodiment. The computer 110 may receive a message at block 302. The message may be formatted and transported according to any known protocol, including TCP/IP, IPX/SPX, UDP/IP, Universal Serial Bus (USB), serial data interface, etc. In one embodiment, the protocol is TCP/IP and the messages are extensible markup language (XML).

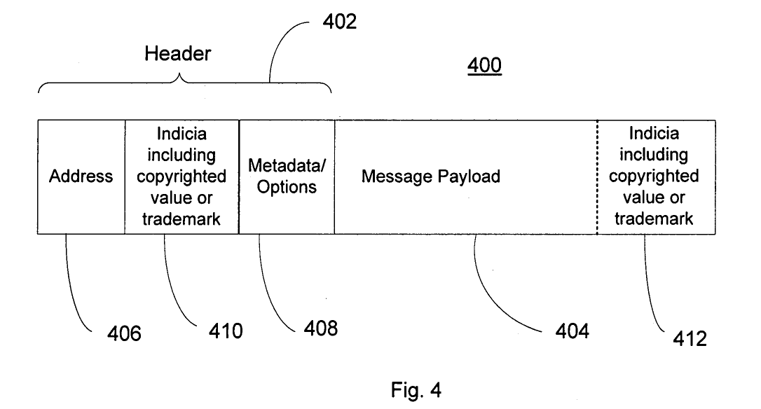

Referring briefly to FIG. 4, an exemplary message suitable for use in interprocess communication is shown. The message 400 may have a header 402 and a payload 404. The header 402 may include an address 406 and metadata 408. The metadata 408 may include options for routing, security information, or protocol-specific information such as packet sequence numbers, time-to-live values, etc. The message payload may be binary data, executable code, script, a database schema, transaction information, etc. Header indicia 410 or payload indicia 412 may be used for authorization or authentication. The header and payload indicia 410 412 may be legally enforceable objects, such as a trademark or a copyrighted value, such as a copyrighted text string. In applications where either or both of the indicia are required, it may be all but evidently obvious to a developer, administrator, or support person writing, configuring or administering the system that that the indicia is a legally enforceable object.

Returning to FIG. 3, after receipt of the message at block 302, the message may be parsed into component elements. Using the example of FIG. 4, the message may first be parsed into header 402 and payload 404 at block 304. Metadata in the message may contain a rule or rules for parsing the indicia 410 412 from message 400. In another embodiment, the message may follow a structure requiring exact placement of the indicia 410 412, or may simply have embedded tags and values to assist in parsing the indicia 410 412 from the message 400. When the message has been parsed it may be examined at block 306 to determine if indicia 410 412 are present. If either or both of the indicia 410 412 are present, the indicia may be verified to determine if one or both includes legally enforceable content, such as a trademark or copyrighted content.

If the indicia includes a trademark, it may need to be displayed. For example, a graphical trademark may not be recognizable in a binary form. However, the receiving program may be programmed to display the trademark when it is expected and is present. When the trademark is not present, or the wrong trademark is present, a default graphic may be displayed along with an error message indicating that an expected value was not present.

When the indicia 410 412 is a copyrighted value, such as text string, it may be programmatically examined to determine if it matches an expected value. As above, if the receiving program determines that the expected copyrighted value is not present, an error message may be displayed. Because many interprocess communications are not associated with user functions, the display of an error message may not always be desirable or even possible. Indicia 410 412 may be present in the header 402, in the payload 404, or in both, depending on the application and the uses. The trademark or copyrighted value of the indicia 410 412 may include a text string, a Unicode character sequence, an ASCII character sequence, a bitmap, a sound sequence, or a video sequence. As discussed more below, since the indicia of 410 412 need only be verified, and not necessarily presented, the exact format of the indicia 410 412 or compatibility with the receiving system may not be important.

Because one embodiment is directed to providing notification to developers or non-user personnel, rather than being associated with a particular user function, messages containing the indicia 410 412 may have a number of different purposes. The nature of the message, or its purpose, may be determined at block 308. At block 310, when the indicia 410 412 meets the appropriate criteria, the message 400 may be processed according to its nature.

If the message payload 404 includes data, the data may be accepted and stored. When the message payload 404 is a transaction request the transaction request may be processed. If the message 400 includes executable code, the executable code may be run. If the message is a heartbeat, that is, a signal from another process sent to confirm presence and/or health, there may not be a specific payload 404. Rather, the mere presence of the message is a signal to the receiving program indicating an action should be taken, such as resetting a watchdog timer. If the receiving system is a router, switch, or message processor, validation of the copyrighted content in the message 400 may allow the message 400 to be forwarded toward an ultimate destination. In one embodiment of the router example, a first indicia 410 412, e.g. one copyrighted value may be validated upon receipt, and that value removed and replaced with a second copyrighted value before transmitting to the next destination.

It should be noted that, in some cases, the payload 404 of a message may include copyrighted content, for example executable code as part of the message payload 404 may be copyrighted. This copyrighted code may be executed at the receiving system after validation, where the validation could be verification of a digital signature or verification of code compatibility. The indicia 410 412 including, for example, a copyrighted value, is distinguished from such copyrighted executable code in that the indicia 410 412 does not serve to forward a purpose for sending the message 400, but rather puts developers or others on notice that the message itself is or includes proprietary subject matter. To that end, the indicia 410 412, may be safely discarded once it is verified, although as described above, at least a portion of the trademarked or copyrighted content may be displayed, as at block 312, to reinforce the notice of proprietary interest.

While the indicia 410 412 may incorporate arbitrary content, such as copyrighted poetry, the trademark or copyrighted content may be selected from a set of content where each selection has a predetermined significance. For example, one embodiment addresses an issue of development or test code find its way into production applications. In this example, a receiving program may accept an interprocess message 400 from a sending process only if the interprocess message 400 includes indicia 410 412 matching its own version type. That is, a development release of the receiving program or process may expect one value for the indicia 410 412 corresponding to a development release of the sending program or process. Similarly, a production release of the receiving program or process may expect a second value for the indicia 410 412 corresponding to a production release of the sending program or process. If a development release of the receiving program receives a message 400 having indicia 410 412 corresponding to a production release, the message 400 may be rejected. Correspondingly, a production release of the receiving program may reject a message 400 including indicia 410 412 corresponding to a development release.

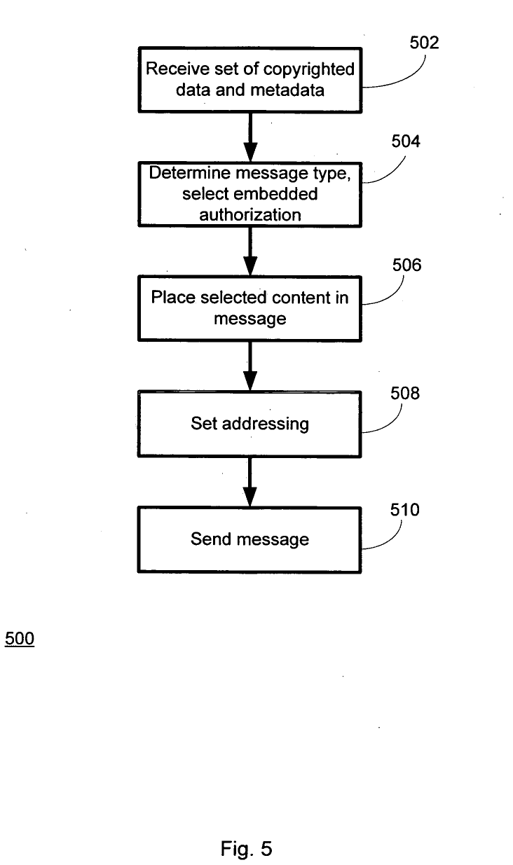

FIG. 5, a method 500 of building and sending a message 400 having an embedded authorization is discussed and described. At block 502, a system, such as computer 110, may receive a set of legally enforceable indicia 410 412, each indicia including a trademark or a copyrighted value. The set may also be accompanied by metadata, that is data about each indicia of 410 412, for use in determining the correct usage of the indicia based on the message type, as discussed below. In some embodiments, the set may be extensive, for example, when a number of different interprocess messages 400 are dynamically constructed and sent. However, in another embodiment, where a single messages sent by a process for a particular purpose, the set may be single value, or the indicia of 410 412 may be included as fixed data stored with the message.

When constructing the message dynamically, the message type, as related to the selection of indicia 400 and 412 may be determined at block 504. For example, a message 400 intended for transaction processing at an endpoint may require a first indicia included in the payload 404, while another message 400 intended for use as a heartbeat may have a second indicia included in the header 402. Indicia 410 412 may be available for message authentication, message routing, message execution, and in a special case message sender identification. In the special case, and indicia, such as a copyrighted value, may be associated with a particular user or sending entity associated with the message 400. Inclusion of the special indicia may be in addition to, as well as in place of, other indicia 410 412. The selected content may be placed into the message at block 506, and any address information 406 or special routing instructions or other options 408, may be incorporated at block 508. Message may then be sent at block 510.

The use of copyrighted content or trademark for the purpose of indicating intellectual property rights provides IP holders with an additional, powerful mechanism for providing notice to developers and other interested parties of such IP rights. Because the inclusion of legally enforceable indicia in an interprocess message cannot be denied by a developer or administrator, IP rights holders will have another mechanism for enforcing their due rights.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

1. A method of validating a message sent between a first and a second entity comprising:
receiving a message;
determining that a predetermined element is present in the message;
verifying that the predetermined element includes copyrighted content; and
validating the message when the copyrighted content is present in the message.

2. The method of claim 1, wherein verifying that the predetermined element includes copyrighted content comprises verifying that the copyrighted content is part of a message header.

3. (canceled)

4. The method of claim 1, further comprising forwarding the message toward a destination when the copyrighted content is present in a message header.

5. The method of claim 1, further comprising determining when the copyrighted content corresponds to a software version associated with an executable code running on one of the first and second entities.

6. The method of claim 5, wherein the software version is one of a development version and a production version and a first copyrighted content corresponds to the development version and a second copyrighted content corresponds to the production version.

7. (canceled)

8. The method of claim 1, further comprising running an executable code portion of a message payload when the validating is successful.

9. The method of claim 1, further comprising presenting a human readable message containing at least a portion of the copyrighted content when the validating the message is successful.

10. The method of claim 1, wherein the copyrighted message is one of a text string, a Unicode character sequence, an ASCII character sequence, a bitmap, a sound sequence, and a video sequence.

11. A computer-readable medium having computer executable instructions for implementing a method of processing a received message on a processing device comprising:
receiving the message;
parsing the message according to a rule;
verifying that a predetermined legally enforceable indicia is present in the message; and
validating the message when the predetermined legally enforceable indicia is present in the message.

12. The computer-readable medium having computer executable instructions for implementing the method of claim 11, wherein the legally enforceable indicia is trademarked content and the method further comprises presenting the trademarked content to a user when the trademarked content is present.

13. (canceled)

14. The computer-readable medium having computer executable instructions for implementing the method of claim 11, wherein accepting the message comprises one of running executable code included in the message, and forwarding the message to a destination described in the message.

15. A computer-readable medium having computer executable instructions for implementing a method for building and sending a message with an embedded authorization on a processing device comprising:
selecting the embedded authorization from a set of copyrighted content according to use for at least one of message authentication, message routing, message executable code execution, and message sender identification;
placing the selected copyrighted content in the message as the embedded authorization; and
sending the message.

16. The computer-readable medium having computer executable instructions of claim 15, wherein selecting the embedded authorization comprises selecting a first copyrighted content from the set when an associated program is a production release and selecting a second copyrighted content from the set when the associated program is a development release.

17. (canceled)

18. The computer-readable medium having computer executable instructions of claim 15, wherein placing the selected copyrighted content in the message comprises placing selected copyrighted content in a message header.

19. (canceled)

20. The computer-readable medium having computer executable instructions of claim 15, wherein incorporating the copyrighted content comprises selecting the copyrighted content for use in message authentication of a heartbeat signal and the copyrighted content is the only payload of the message.
